(19) United States
(12) Patent Application Publication
(10) Pub. No.: US 2007/0184413 A1
(43) Pub. Date: Aug. 9, 2007

(54) Pre-coated root canal filling point

(75) Inventors: Barry L. Musikant, New York, NY (US); Allan S. Deutsch, New York, NY (US); Brian Rasimick, New York, NY (US); Quan Gu, New Milford, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Essential Dental Systems, Inc., South Hackensack, NJ (US)

(21) Appl. No.: 11/528,083

(22) Filed: Sep. 27, 2006

Related U.S. Application Data
(60) Provisional application No. 60/721,283, filed on Sep. 28, 2005.

(51) Int. Cl. A61C 5/02

(52) U.S. Cl. 433/224

(57) ABSTRACT

A gutta percha point includes a shaft having a first end and a second end opposite the first end. The shaft defines a first region having a first taper, the first region extending from the first end of the shaft, and a second region having a second taper, the second region extending between the first tapered region and the second end of the shaft. The second taper of the second region is greater than the first taper of the first region. The shaft may include a third region extending between the second region and the second end of the shaft.

### CROSS-REFERENCE TO RELATED APPLICATIONS

The present application claims benefit of U.S. Provisional Application Ser. No. 60/721,283, filed Sep. 28, 2005, the disclosure of which is hereby incorporated by reference herein. The present application is related to U.S. patent application Ser. No. ______, filed on even date herewith, entitled “Epoxy Based Oil Free Root Canal Sealer,” [ESSEN 3.0-024], the disclosure of which is hereby incorporated by reference herein.

### BACKGROUND OF THE INVENTION

The present invention relates to root canal procedures and more particularly relates to gutta percha points used in root canal procedures.

Gutta percha points have been used for more than 50 years in dental procedures. Generally, a gutta percha point is used to fill a root canal after the diseased and soft tissue from a tooth's root canal has been removed. A gutta percha point typically includes a mixture of polymer (trans isoprene), zinc oxide, bismuth salt, barium salt, wax, color pigment and other additives. One problem with using gutta percha points is that it is difficult to bond and seal the gutta percha point against a root canal sealer. Root canal sealers, such as those sold under the names AH-26, AH-Plus and EZ-Fill, are epoxy resins filled with heavy metal salts such as radiopacifiers and other additives. Though published data indicates that these epoxy based root canal sealers bond to gutta percha points to some degree, the bond is often compromised due to insufficient coating of the sealer on the gutta percha point.

There have been a number of developments associated with improved gutta percha points. For example, U.S. Patent Application Publication No. 2004/0202986 to Hascke discloses an adhesive endodontic cone. Referring to FIG. 1 thereof, the endodontic cone 10 includes an insertion tip 12 and an adhesive coating 14 on at least a portion of a surface of the endodontic cone 10. The adhesive 14 renders the cone 10 more chemically compatible with a hydrophilic endodontic resin. As discussed in paragraph 28 of the '986 publication, providing an “endodontic cone that is more chemically compatible with a hydrophilic endodontic resin facilitates complete sealing between the endodontic cone, and endodontic sealant resin, and the hydrophilic root canal chamber.”

U.S. Pat. No. 5,275,562 to McSpadden discloses a gutta percha point that is coated with a methyl methacrylate layer, which increases the rigidity of the gutta percha core.

U.S. Patent Application Publication No. 2004/0137404 to Koch et al. discloses a gutta percha cone having a textured exterior surface designed for increasing the surface area of the gutta percha cone and thereby increasing retention within the root canal. Referring to FIG. 1 thereof, the gutta percha cone 10 has a reticulated framework 20 of varying textures 20A.

U.S. Pat. No. 6,602,516 to Martin discloses a gutta percha point having an antibacterial agent incorporated therein for minimizing the likelihood of bacteria formation within the root canal. Similarly, U.S. Pat. No. 5,648,403 to Martin discloses a gutta percha cone having an antimicrobial agent incorporated therein.

In spite of the above developments, there remains a need for a pre-coated gutta percha point that is able to more readily bond to root canal sealers. There is also a need for a gutta percha point that effectively fits into a prepared root canal. In addition, there remains a need for an improved, tapered gutta percha point.

### BRIEF DESCRIPTION OF THE DRAWINGS

FIG. 1 shows a gutta percha point having an epoxy resin coating, in accordance with certain preferred embodiments of the present invention.

FIG. 2 shows a gutta percha point having an epoxy resin coating, in accordance with another preferred embodiment of the present invention.

FIG. 3 shows a gutta percha point having an epoxy resin coating that is in contact with a root canal sealer, in accordance with further preferred embodiments of the present invention.

FIG. 4 shows a gutta percha point fitted into a canal formed in a block, in accordance with certain preferred embodiments of the present invention.

FIG. 5 shows a block having a canal formed therein, in accordance with certain preferred embodiments of the present invention.

FIG. 6 shows a block having a canal formed therein and a gutta percha point inserted into the canal, in accordance with certain preferred embodiments of the present invention.

### SUMMARY OF THE INVENTION

In certain preferred embodiments, the present invention provides a gutta percha point or root canal filling point that effectively bonds to a root canal sealer, and more easily fits within a canal well.

In certain preferred embodiments, an unfilled root canal sealer resin based on epoxy chemistry is used to pre-coat a gutta percha point. The diepoxide part of the resin may be bisphenol A-diglycidylether or bisphenol F-diglycidylether, and the diamine part of the resin may be hexamethylene tetramine, adamantine amine, N,N-dibenzyl-5-oxanonane-diamine-1,9, TCD-diamine, polyamide veramid 140 and/or versamid 125. The unfilled resin may be provided on the gutta percha point by being spray or dip coated on the gutta percha point. In certain preferred embodiments, in order to further enhance adhesion of the root canal sealer to the gutta percha point, a grid texture may be provided on the gutta percha point.

In other preferred embodiments of the present invention, gutta percha points from diadent may be evenly coated with unfilled epoxy resin. The epoxy resin coating preferably has a thickness of about 10 μm, and preferably extends from the tip end to about 20 mm from the tip. In certain preferred embodiments, the volume ratio of A-diglycidylether versus versamid 140 in cured coating is 1:1.

In order to enhance fitting of the gutta percha point into the root canal, various sizes such as medium, medium-large and large sized gutta percha points may be provided, whereby the gutta percha points have three or more different tapers.

Although the present invention is not limited by any particular theory of operation, it is believed that providing a multiple taper along the length of the gutta percha point 1) promotes better fitting between a gutta percha point and an instrumented root canal space, 2) minimizes the amount of tooth structure that must be removed, and 3) provides a significant level of resistance to prevent the gutta percha point from extruding beyond the apex of the canal.

In one preferred embodiment of the present invention, the gutta percha point has more than one taper or multiple tapers. The advantages provided by a multiple taper will work effectively in root canals formed using endodontic instruments, such as the non-circular endodontic instrument disclosed in commonly assigned U.S. Pat. No. 6,042,376, the disclosure of which is hereby incorporated by reference herein. The gutta percha point disclosed herein will also work effectively with systems that recognize the advantages of changing tapers as the shaping of the canal extends coronally from the apex.

For example, a MB root might be very thin in its most apical 3 mm. Consequently, an apical preparation of 35 would remove less tooth structure if its most apical 3 mm had a taper of about 0.05 mm/mm taper. Coronal to the apical 3 mm, the canal may widen and be better cleansed and obturated with a 0.08 mm/mm taper for about 4 mm. In the coronal portion, the dimensions of the canal may be similar to the dimensions in the middle third, requiring a minimal or no taper along this length or at this level. Although the present invention is not limited by any particular theory of operation, it is believed that providing gutta percha points with multiple tapers provides greater flexibility in accommodating a more intimate fit of a gutta percha point to a canal space, whereby the canal space has been shaped in a more physiological way.

In certain preferred embodiments, a medium-sized gutta percha point has a 0.04 mm taper from 0 to 3 mm, a 0.06 mm taper from 3 to 11 mm, and a 0.00 mm taper after 11 mm. In other preferred embodiments, a medium-large size gutta percha point has a 0.04 mm taper from 0 to 2 mm, a 0.07 mm taper from 2 to 10 mm, and a 0.00 mm taper after 10 mm. In still other preferred embodiments, a large size gutta percha point has a 0.05 mm taper from 0 to 4 mm, a 0.10 mm taper from 4 to 9 mm, and a 0.00 taper after 9 mm. The medium, medium-large and large size may start with 0.30 to 0.34 mm diameter tips at length 0 mm. For the 40's to 90's sized gutta percha points, there may be only two tapers on each point. For the 40's, from 0 to 6 mm may have a 0.10 mm taper, and a 0.00 mm taper after 6 mm. For the 50's, from 0 to 5 mm may have a 0.10 mm taper, and a 0.00 mm taper after 5 mm. For the 60's, from 0 to 4 mm may have a 0.10 mm taper, and a 0.00 mm taper after 4 mm. For the 70's, from 0 to 3 mm may have a 0.10 mm taper, and a 0.00 mm taper after 3 mm. For 80's, from 0 to 3 mm may have a 0.10 mm taper, and a 0.00 mm taper after 3 mm. For 90's, from 0 to 1 mm may have a 0.10 mm taper, and a 0.00 mm taper after 1 mm.

### DETAILED DESCRIPTION OF PREFERRED EMBODIMENTS

### Coating Example 1

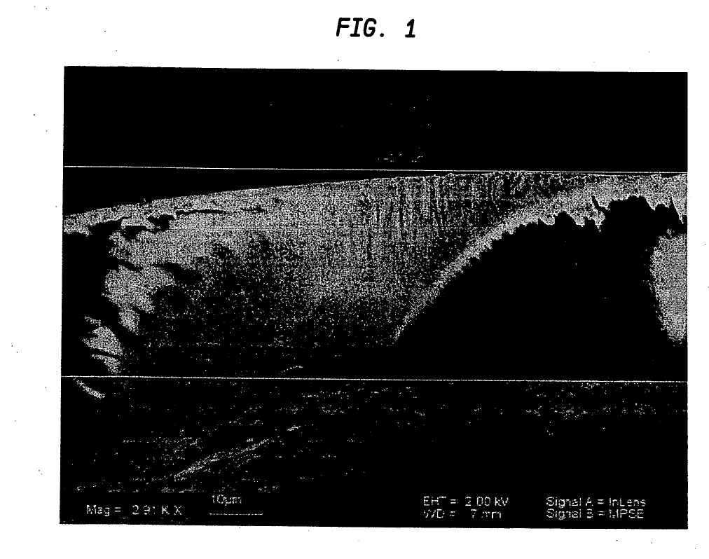

In certain preferred embodiments of the present invention, gutta percha points from diadent were coated with unfilled epoxy resin. The coating had a thickness of about 40 μm, and the coating extended from the tip end of the point to a distance of about 20 mm from the point. The volume ratio of A-diglycidylether versus versamid 140 in cured coating was 1:1. FIG. 1 shows the intimate attachment between the coating and the gutta percha point.

### Coating Example 2

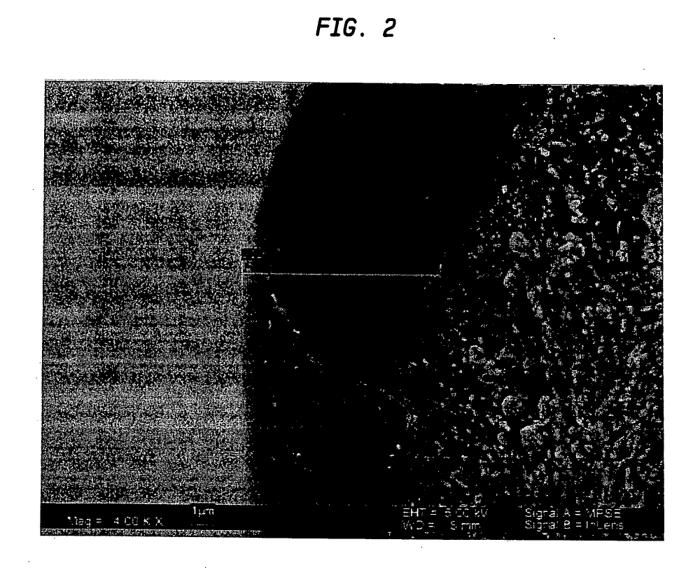

In other preferred embodiments of the present invention, gutta percha points from diadent were evenly coated with unfilled epoxy resin. The epoxy resin coating had a thickness of about 10 μm, and extended from the tip end to about 20 mm from the tip. The volume ratio of A-diglycidylether versus versamid 140 in cured coating was 1:1. FIG. 2 shows the intimate attachment between the coating and the gutta percha point.

### Coating Example 3

A canal was formed in an extracted tooth using one or more of the instruments disclosed in commonly assigned U.S. Pat. No. 6,042,376, the disclosure of which is hereby incorporated by reference herein. The root canal sealer disclosed in commonly assigned U.S. Provisional Application Ser. No. 60/721,309, entitled, “Root Canal Sealer and Pre-coated Root Canal Filling Point,” filed Sep. 28, 2005, the disclosure of which is hereby incorporated by reference herein, was applied with Ez-Fill bi-spiral. FIG. 3 shows the intimate contact of the coating with both the gutta percha point and an epoxy based root canal sealer disclosed in the above-mentioned '309 provisional application.

In certain preferred embodiments of the present invention, the gutta percha point may have a taper, or multiple tapers.

### Example 4—Tapered Gutta-Percha Points

Medium, medium-large and large size gutta-percha points with the following dimension were made from gutta-percha pellets. The gutta percha points were fitted into canals pre-formed in plastic blocks. The canals may be formed using the instrumentation and techniques disclosed in commonly assigned U.S. Pat. No. 6,042,376, the disclosure of which is hereby incorporated by reference herein. In certain preferred embodiments, the dimensions are as set forth below in Table I.

TABLE I

| length | M | taper | ML | taper | L | taper |
|---|---|---|---|---|---|---|
| 0 | 0.33 | 0 | 0.33 | 0 | 0.33 | 0 |
| 1 | 0.37 | 0.04 | 0.37 | 0.04 | 0.38 | 0.05 |
| 2 | 0.41 | 0.04 | 0.41 | 0.04 | 0.43 | 0.05 |
| 3 | 0.45 | 0.04 | 0.48 | 0.07 | 0.48 | 0.05 |
| 4 | 0.51 | 0.06 | 0.55 | 0.07 | 0.53 | 0.05 |
| 5 | 0.57 | 0.06 | 0.62 | 0.07 | 0.63 | 0.10 |
| 6 | 0.63 | 0.06 | 0.69 | 0.07 | 0.73 | 0.10 |
| 7 | 0.69 | 0.06 | 0.76 | 0.07 | 0.83 | 0.10 |
| 8 | 0.75 | 0.06 | 0.83 | 0.07 | 0.93 | 0.10 |
| 9 | 0.81 | 0.06 | 0.90 | 0.07 | 1.03 | 0.10 |
| 10 | 0.87 | 0.06 | 0.97 | 0.07 | 1.03 | 0.00 |
| 11 | 0.93 | 0.06 | 0.97 | 0.00 | 1.03 | 0.00 |
| 12 | 0.93 | 0.00 | 0.97 | 0.00 | 1.03 | 0.00 |
| ˜ | 0.93 | 0.00 | 0.97 | 0.00 | 1.03 | 0.00 |
| 30 | 0.93 | 0.00 | 0.97 | 0.00 | 1.03 | 0.00 |

### Example 4—Tapered Gutta-Percha Points

In certain preferred embodiments, medium, medium-large and large size gutta-percha points with the following dimension may be prepared using gutta-percha pellets. The gutta percha points may be fit into pre-formed plastic blocks to examine the fit. In certain preferred embodiments, the dimensions are as set forth below in Table II.

TABLE II

| length | M | taper | ML | taper | L | taper |
|---|---|---|---|---|---|---|
| 0 | 0.32 | 0 | 0.32 | 0 | 0.32 | 0 |
| 1 | 0.36 | 0.04 | 0.36 | 0.04 | 0.37 | 0.05 |
| 2 | 0.40 | 0.04 | 0.40 | 0.04 | 0.42 | 0.05 |
| 3 | 0.44 | 0.04 | 0.47 | 0.07 | 0.47 | 0.05 |
| 4 | 0.50 | 0.06 | 0.54 | 0.07 | 0.52 | 0.05 |
| 5 | 0.56 | 0.06 | 0.61 | 0.07 | 0.62 | 0.10 |
| 6 | 0.62 | 0.06 | 0.68 | 0.07 | 0.72 | 0.10 |
| 7 | 0.68 | 0.06 | 0.75 | 0.07 | 0.82 | 0.10 |
| 8 | 0.74 | 0.06 | 0.82 | 0.07 | 0.92 | 0.10 |
| 9 | 0.80 | 0.06 | 0.89 | 0.07 | 1.02 | 0.10 |
| 10 | 0.86 | 0.06 | 0.96 | 0.07 | 1.02 | 0.00 |
| 11 | 0.92 | 0.06 | 0.96 | 0.00 | 1.02 | 0.00 |
| 12 | 0.92 | 0.00 | 0.96 | 0.00 | 1.02 | 0.00 |
| ˜ | 0.92 | 0.00 | 0.96 | 0.00 | 1.02 | 0.00 |
| 30 | 0.92 | 0.00 | 0.96 | 0.00 | 1.02 | 0.00 |

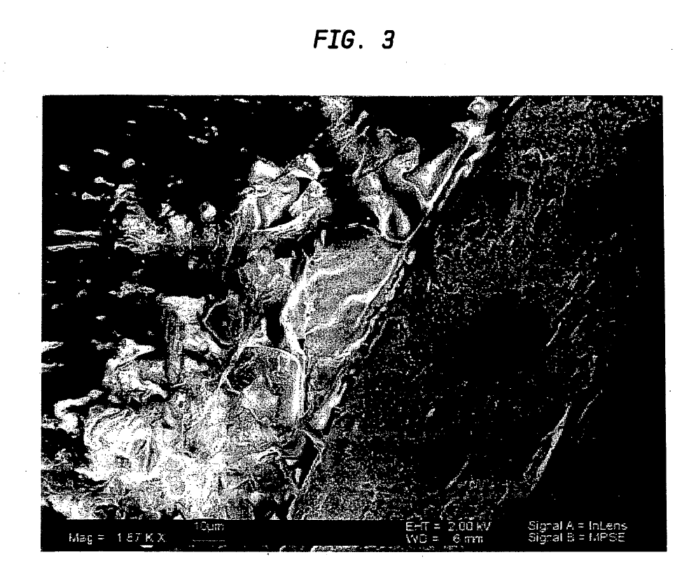

FIG. 4 shows a large sized gutta percha point fitted into a canal formed in a plastic block, as described herein.

FIG. 5 shows a plastic block having a canal formed using one or more instruments disclosed in U.S. Pat. No. 6,042,376. An “L” sized gutta percha point is inserted into the canal and cemented in place using the epoxy based root canal sealer disclosed in commonly assigned U.S. Provisional Application Ser. No. 60/721,309, Filed Sep. 28, 2005, and entitled “Root Canal Sealer and Pre-Coated Root Canal Filling Point.”

### Example 5—Tapered Gutta-Percha Points

In certain preferred embodiments of the present invention, 40's, 50's, 60's, 70's, 80's and 90's sized gutta-percha points with the dimensions shown in Table III are made from gutta-percha pellets. The gutta-percha points are preferably fit into canals formed in plastic blocks, as discussed herein. The clear plastic blocks allow the fit of the point in the canal to be observed. Preferred dimensions may be as shown in Table III.

TABLE III

| length | 40's | taper | 50's | taper | 60's | taper | 70's | taper | 80's | taper | 90's | taper |
|---|---|---|---|---|---|---|---|---|---|---|---|---|
| 0 | 0.40 | 0 | 0.50 | 0 | 0.60 | 0 | 0.70 | 0 | 0.80 | 0 | 0.90 | 0 |
| 1 | 0.50 | 0.10 | 0.60 | 0.10 | 0.70 | 0.10 | 0.80 | 0.10 | 0.90 | 0.10 | 1.00 | 0.10 |
| 2 | 0.60 | 0.10 | 0.70 | 0.10 | 0.80 | 0.10 | 0.90 | 0.10 | 1.00 | 0.10 | 1.00 | 0.00 |
| 3 | 0.70 | 0.10 | 0.80 | 0.10 | 0.90 | 0.10 | 1.00 | 0.10 | 1.00 | 0.00 | 1.00 | 0.00 |
| 4 | 0.80 | 0.10 | 0.90 | 0.10 | 1.00 | 0.10 | 1.00 | 0.00 | 1.00 | 0.00 | 1.00 | 0.00 |
| 5 | 0.90 | 0.10 | 1.00 | 0.10 | 1.00 | 0.00 | 1.00 | 0.00 | 1.00 | 0.00 | 1.00 | 0.00 |
| 6 | 1.00 | 0.10 | 1.00 | 0.00 | 1.00 | 0.00 | 1.00 | 0.00 | 1.00 | 0.00 | 1.00 | 0.00 |
| 7 | 1.00 | 0.00 | 1.00 | 0.00 | 1.00 | 0.00 | 1.00 | 0.00 | 1.00 | 0.00 | 1.00 | 0.00 |
| 8 | 1.00 | 0.00 | 1.00 | 0.00 | 1.00 | 0.00 | 1.00 | 0.00 | 1.00 | 0.00 | 1.00 | 0.00 |
| 9 | 1.00 | 0.00 | 1.00 | 0.00 | 1.00 | 0.00 | 1.00 | 0.00 | 1.00 | 0.00 | 1.00 | 0.00 |
| ˜ | | | | | | | | | | | | |
| 32 | 1.00 | 0.00 | 1.00 | 0.00 | 1.00 | 0.00 | 1.00 | 0.00 | 1.00 | 0.00 | 1.00 | 0.00 |

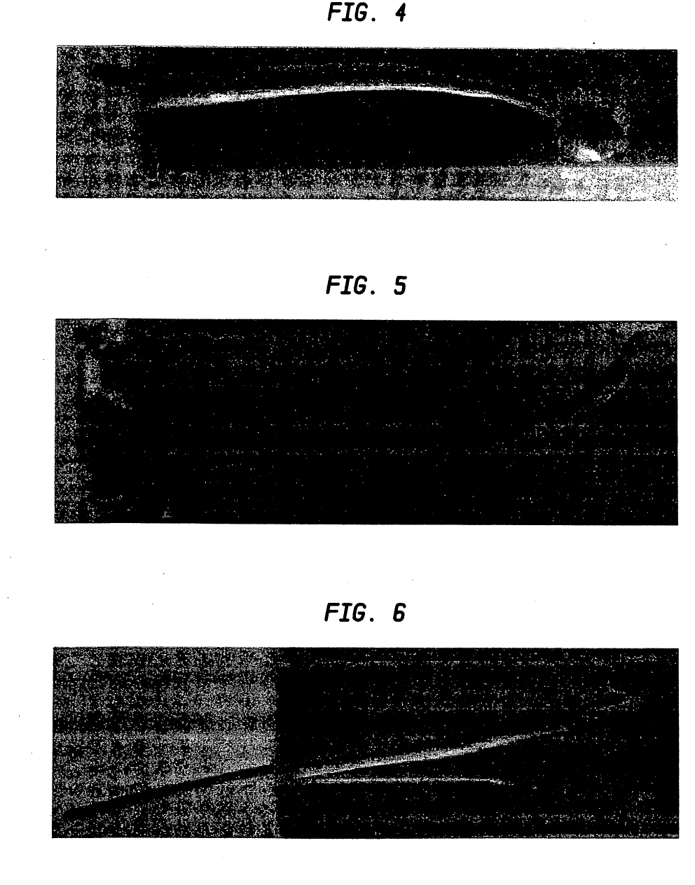

FIG. 6 shows a plastic block instrumented and fit with a 90's sized gutta percha point.

### Example 6—Gutta Percha Point Fit Test

45 recently extracted human single rooted teeth were sectioned at the cemento-enamel junction (CEJ) using a diamond disc. A root canal was formed in each tooth using the instrumentation disclosed in commonly assigned U.S. Pat. No. 6,042,376, the disclosure of which is hereby incorporated by reference herein. In certain preferred embodiments, the system disclosed in the '376 patent utilizes a combination of stainless steel and rotary nickel-titanium reamers in a reciprocating handpiece. In certain preferred embodiments, patency is established with a number 08 reamer and a working length is determined. Then number 10, 15, and 20 reamers are negotiated to the apex using quick pecking motions of the reciprocating handpiece. Next, a number 2 peeso reamer is drilled to within 6 mm of the apex using a low speed handpiece. The peeso is preferably used to help straighten the canal, if necessary. Then number 25, 30, and 35 reamers are negotiated to the apex using the reciprocating handpiece. A 0.40 reamer may then be used to within 1 mm of the apex. Next, a number 2 gate glidden drill in a low-speed handpiece is used to reach between 2 and 3 mm from the apex. Finally, 30 0.06 and 25 0.08 taper NiTi instruments are used in the reciprocating handpiece for reaching the apex. After each instrument is used, the canal may be irrigated such as by alternately irrigating with 5.25% NaOCl (Chlorox) or 17% REDTA (Roth). The canals may then be irrigated with distilled water and dried with paper points.

The gutta-percha points identified in Table IV below were placed into the canals. The Lexicon Gutta Percha points, manufactured by Tulsa Dental of Tulsa, Okla., have a constant 0.06 taper from the tip to the opposite end. Each tooth-point combination was photographed in both bucco-lingual and mesio-distal views on a 1 mm x-ray grid. The fit of each point into each canal was classified as either “long” (over 1 mm beyond the apical foramen), “fit” (less than 1 mm beyond the apical foramen and no more than 0.5 mm short of the foramen), or “short” (over 0.5 mm short of the apical foramen).

The results are presented in Table IV below. The points that fit the best are example 2 ML, example 2M, and example 1 ML. These points fit the canals much better than 0.06 taper points. Example 2L also fits many canals, however, it is short in too many cases to be considered optimal. Points that extend past the foramen can be trimmed by the clinician. Points that are short of the foramen cannot be easily made to extend further.

TABLE IV

| Tooth | | Lexicon | Lexicon | Lexicon | Example | Example | Example | Example | Example | Example |
|---|---|---|---|---|---|---|---|---|---|---|
| Type | | 25 0.06 | 30 0.06 | 35 0.06 | 1 M | 1 ML | 1 L | 2 M | 2 ML | 2 L |
| Canines | Long | 2 | 2 | 0 | 10 | 8 | 1 | 8 | 4 | 3 |
| | Fit | 2 | 1 | 0 | 1 | 3 | 1 | 3 | 5 | 5 |
| | Short | 7 | 8 | 11 | 0 | 0 | 9 | 0 | 2 | 3 |
| Incisors | Long | 2 | 0 | 1 | 12 | 8 | 0 | 8 | 5 | 0 |
| | Fit | 1 | 3 | 1 | 1 | 5 | 5 | 5 | 6 | 10 |
| | Short | 10 | 10 | 11 | 0 | 0 | 8 | 0 | 2 | 3 |
| Lower | Long | 1 | 1 | 0 | 13 | 5 | 1 | 4 | 2 | 1 |
| Bicuspids | Fit | 1 | 1 | 0 | 2 | 10 | 1 | 11 | 11 | 5 |
| | Short | 13 | 13 | 15 | 0 | 0 | 13 | 0 | 2 | 9 |
| Upper | Long | 1 | 1 | 0 | 4 | 4 | 0 | 4 | 4 | 0 |
| Bicuspids | Fit | 2 | 1 | 0 | 2 | 2 | 2 | 2 | 2 | 2 |
| | Short | 3 | 4 | 6 | 0 | 0 | 4 | 0 | 0 | 4 |
| Total | Long | 6 | 4 | 1 | 39 | 25 | 2 | 24 | 15 | 4 |
| | Fit | 6 | 6 | 1 | 6 | 20 | 9 | 21 | 24 | 22 |
| | Short | 33 | 35 | 43 | 0 | 0 | 34 | 0 | 6 | 19 |

The multiple-taper gutta percha points disclosed in the present invention fit better than the Lexicon 0.06 taper points. The Lexicon 0.06 taper points tend to be “short” in single rooted teeth. This requires use of a smaller point or re-instrumentation of the canal. When the gutta percha points disclosed in the present application did not fit, they tended to be long, a much better scenario than short. As is known to those skilled in the art, long points can be trimmed to better fit the canal.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A gutta percha point comprising:
a shaft having a first end and a second end opposite said first end;
said shaft defining a first region having a first taper, said first region extending from said first end of said shaft, and a second region having a second taper, said second region extending between said first tapered region and said second end of said shaft, wherein said second taper of said second region is greater than said first taper of said first region.

2. The gutta percha point as claimed in claim 1, wherein said shaft further comprises a third region extending between said second region and said second end of said shaft.

3. The gutta percha point as claimed in claim 2, wherein said third region of said shaft has no taper.

4. The gutta percha point as claimed in claim 2, wherein said third region of said shaft has a third taper, wherein said third taper is less than said first and second tapers.

5. The gutta percha point as claimed in claim 1, further comprising an epoxy resin coating provided on said shaft.

6. The gutta percha point as claimed in claim 5, wherein said epoxy resin coating comprises an unfilled resin.

7. The gutta percha point as claimed in claim 5, wherein said epoxy resin coating in spray or dip coated onto said gutta percha point.

8. The gutta percha point as claimed in claim 1, wherein said gutta percha point has a textured exterior surface.

9. The gutta percha point as claimed in claim 8, wherein said textured exterior surface comprises a grid pattern.

10. The gutta percha point as claimed in claim 1, wherein said gutta percha point comprises diadent that is coated with an unfilled epoxy resin.

11. The gutta percha point as claimed in claim 5, wherein said epoxy resin coating has a thickness of about 10 microns.

12. The gutta percha point as claimed in claim 5, wherein said epoxy resin coating extends from said first end of said shaft to about 20 mm from said first end of said shaft.

13. The gutta percha point as claimed in claim 1, wherein said shaft has at least two different tapers.

14. The gutta percha point as claimed in claim 1, wherein said gutta percha point comprises diadent coated with an unfilled epoxy resin having a thickness of about 40 microns and the coating extends from the first end said shaft to a distance of about 20 mm from the first end.

15. A gutta percha point comprising:
a shaft having a first end and a second end opposite said first end;
said shaft defining a first region having a first taper, said first region extending from said first end of said shaft, and a second region having a second taper, said second region extending between said first tapered region and said second end of said shaft, wherein said second taper of said second region is greater than said first taper of said first region, and wherein said shaft further comprises a third region extending between said second region and said second end of said shaft; and
an epoxy resin coating provided on said shaft.

16. The gutta percha point as claimed in claim 15, wherein said third region of said shaft has no taper.

17. The gutta percha point as claimed in claim 15, wherein said third region of said shaft has a third taper, wherein said third taper is less than said first and second tapers.

18. The gutta percha point as claimed in claim 15, wherein said shaft of said gutta percha point has a textured exterior surface with a grid pattern.

19. The gutta percha point as claimed in claim 15, wherein said gutta percha point comprises diadent that is coated with said epoxy resin.

20. The gutta percha point as claimed in claim 15, wherein said epoxy resin coating has a thickness of about 10 microns, and said epoxy resin coating extends from said first end of said shaft to about 20 mm from said first end of said shaft.
